(19) United States
(12) Patent Application Publication
(10) Pub. No.: US 2014/0113758 A1
(43) Pub. Date: Apr. 24, 2014

(54) MODULAR TRANSMISSION CHAIN BELT

(71) Applicant: WEN-CHIH HUANG, Chang-Hua City (TW)

(72) Inventor: WEN-CHIH HUANG, Chang-Hua City (TW)

(21) Appl. No.: 13/655,364

(22) Filed: Oct. 18, 2012

(51) Int. Cl. F16G 13/07

(52) U.S. Cl. 474/212

(57) ABSTRACT

The present invention provides a modular transmission chain belt for driving a transmission device, said transmission chain belt being driven by a sprocket having a plurality of tooth portions provided for driving said transmission chain belt, comprising a plurality of linkages and a plurality of connecting shafts. Each one of the linkages comprises a linkage body, a male connector and a female connector provided on two ends of said linkage body, a blind-perforation provided on a bottom surface of said linkage body. Each one of said linkages is attached to one another nearby with the male connector and the female connector thereof to form said transmission chain belt. Each one of the tooth portions is engaged into the blind-perforation of the linkage one by one to drive said transmission belt to rotate along a circulating path.

### BACKGROUND OF THE INVENTION

1. Technical Field

The present invention is related to a transmission chain belt, in particular, to a modular transmission chain belt capable of being cleaned with ease and preventing external matters to be rolled therein.

2. Description of Related Art

For automatic manufacturing lines, conveyor belts are common and frequently used for reliably transporting and distributing objects. Known conveyor belts are often driven by a multi-chain belt arranged at the bottom.

The current existing transmission chain belt structure mostly comprises a plurality of linkages and axles pivotally attached among the linkages, and said linkages can be pivotally attached to each other to meet a predetermined length of usage. The conveyor belt is mainly driven by a sprocket; therefore, each one of the linkages is correspondingly provided with a through-hole such that following the rotation of the sprocket, the tooth portions of the sprocket engages against the through-holes of the sprocket in order to move the conveyor belt along a transmission path and to achieve the practical purpose of transporting the objects.

To facilitate the maintenance and repair of transmission chain belt, the abovementioned through-holes of the linkages are mostly configured to be of a through-hole type. Although such design is able to provide an interface to be driven by the sprocket, the parts or external matters on the conveyor belt are prone to fall into the through-holes, which would cause mal-operation of the machinery, dust to be accumulated around the circumference of the through-holes and hard for cleaning or in the worse cases of danger and unsafe operations that the fingers of or garments worn by the operators might too accidentally stuck at the through-holes of the linkages during the operation of the conveyor machine and are rolled in by the machine if they fail to be released or escaped immediately.

### BRIEF SUMMARY OF THE INVENTION

The present invention provides a modular transmission chain belt capable of utilizing the blind-perforation structure provided thereon to prevent intrusions of such as water and external matters therein and to facilitate the operation of the machinery.

Another objective of the present invention is to utilize a moveable lid covering the top of the through-hole such that a blind-perforation is constructed to block external objects from falling therein and such that as the lid is lifted, it is facilitated for the operations of repair, external matter expelling or chain belt cleaning.

In view of the above, the present invention provides a modular transmission chain belt for driving a transmission device, said transmission chain belt being driven by a sprocket having a plurality of tooth portions provided for driving said transmission chain belt, comprising: a plurality of linkages and a plurality of connecting shafts. Each one of said linkages comprises a linkage body, a male connector and a female connector provided on two ends of said linkage body, a blind-perforation provided on a bottom surface of said linkage body. Each one of said linkages is attached to one another nearby with said male connector and said female connector thereof to form said transmission chain belt, and each one of said tooth portions is engaged into said blind-perforation of said linkage one by one to drive said transmission belt to rotate along a circulating path. In addition, each one of said connecting shafts is pivotally attached to said male connector and said female connector of said linkages.

### BRIEF DESCRIPTION OF THE SEVERAL VIEWS OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is an assembly view of the first embodiment of the modular transmission chain belt of the present invention;

FIG. 2 is a perspective view of the linkage of the transmission chain belt;

FIG. 3 is another perspective view of the linkage of the transmission belt;

FIG. 4 is a bottom view of the linkage of the transmission belt;

FIG. 5 is a cross sectional view along Line 5-5 of FIG. 4;

FIG. 6 is a perspective view showing an outer appearance of the linkage with sliding blocks provided thereon of the transmission chain belt;

FIG. 7 is illustration showing the linkages of the transmission belt following along a curve transportation path;

FIG. 8 is a perspective view of the second embodiment of the linkage of the transmission chain belt of the present invention;

FIG. 9 is a cross sectional view taken along Line 9-9 of FIG. 8, showing the lid covering on top of the through-hole;

FIG. 10 is a cross sectional view similar to the one of FIG. 9, showing the lid being lifted away from said through-hole; and

FIG. 11 is another perspective view of the linkage, showing the plural fine grooves on a bottom portion of the linkage body.

### DETAILED DESCRIPTION OF THE INVENTION

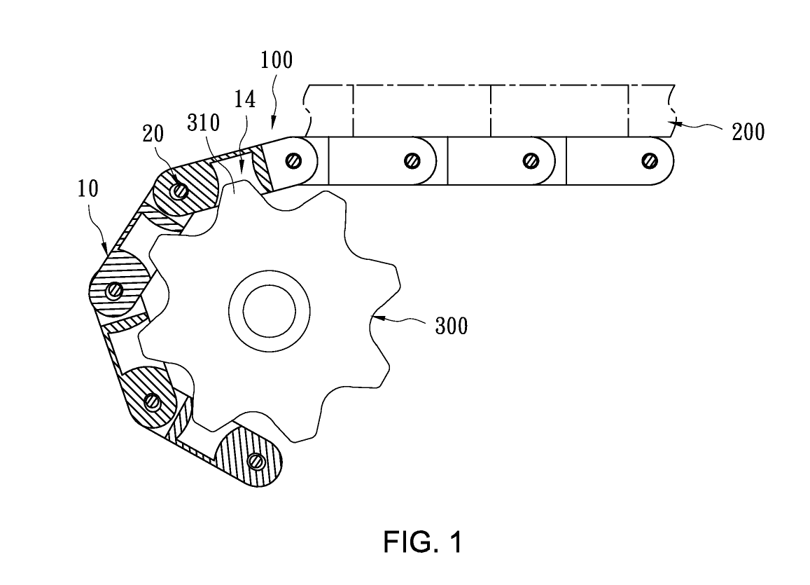

As shown in FIG. 1, in the first embodiment of the modular transmission chain belt of the present invention, said transmission chain belt 100 is provided for driving a transmission device 200 and said transmission chain belt 100 is driven by a sprocket 300. Said sprocket 300 comprises a plurality of tooth portions 310 provided for driving the transmission chain belt 100.

The transmission chain belt 100 comprises a plurality of linkages 10 and a plurality of connecting shafts 20 provided for connecting with the linkages. In this embodiment, in order to meet the requirement of cleaning and ant-rusting, the linkages 10 of the transmission chain belt 100 are made of plastic materials.

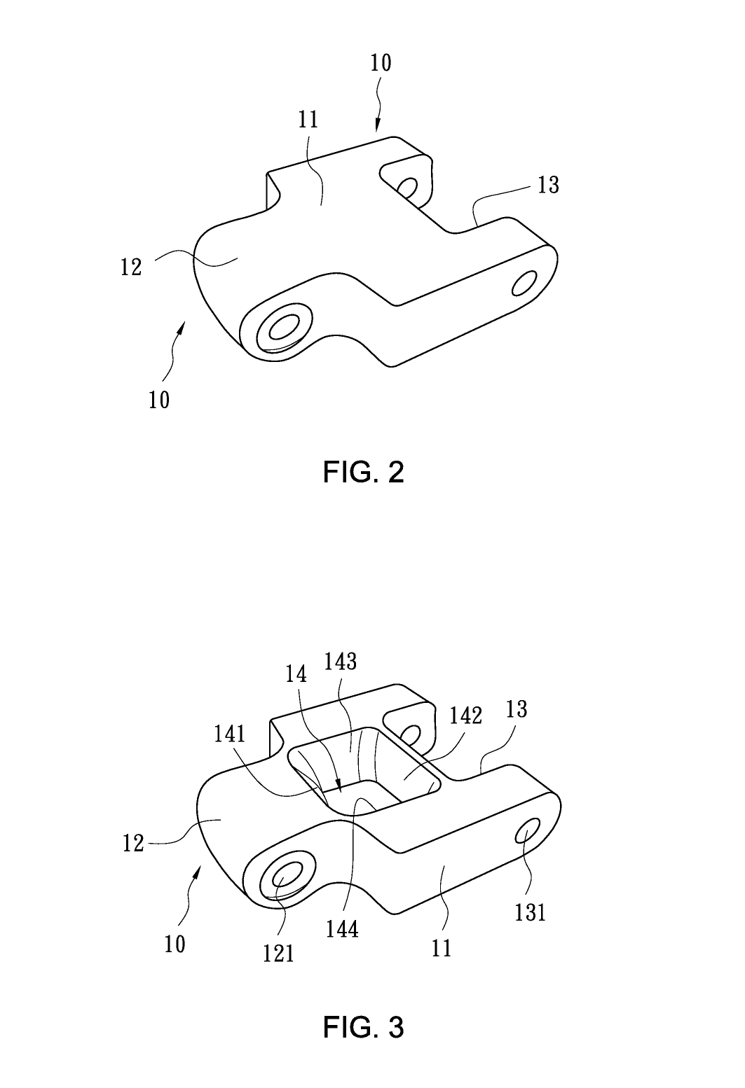

As shown in FIGS. 2 and 3, each one of the linkages 10 comprises a linkage body 11, a male connector 12 and a female connector 13 provided on two ends of said linkage body 11. In addition, a blind-perforation 14 is provided on a bottom surface 111 of said linkage body 11.

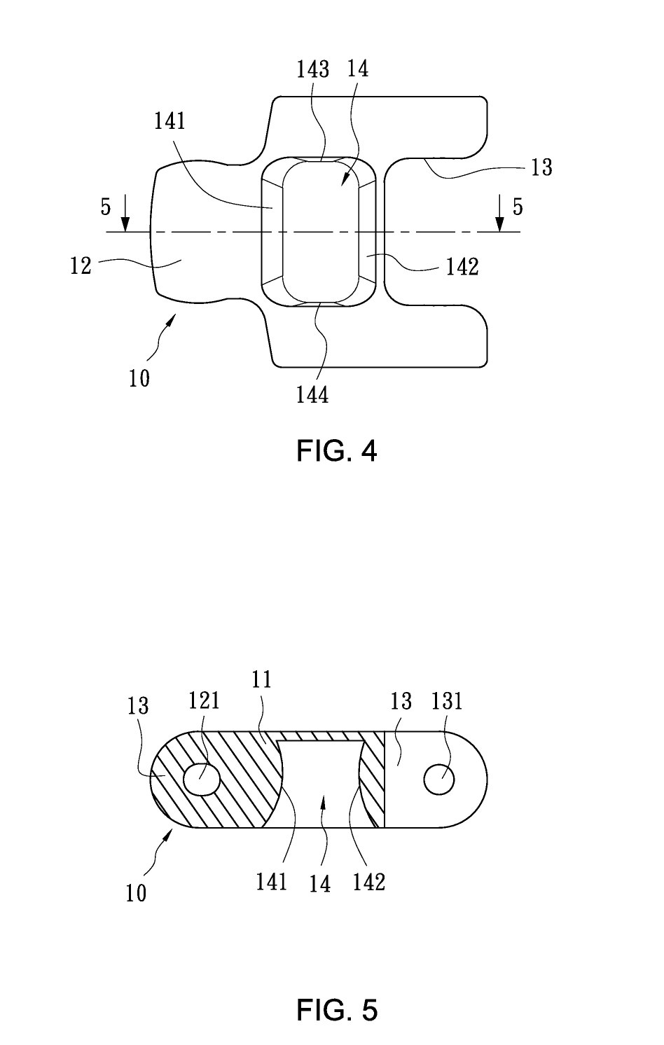

As shown in FIGS. 3, 4 and 5, said blind-perforation 14 comprises four perforation walls 141, 142, 143, 144; and wherein two perforation walls 141, 142 corresponding to each other are of an arc shape. The male connector 12 and the female connector 13 of the linkages 10 are of a reverse-U shape, and each one of the male connectors 12 and the female connectors 13 further comprises an axial-hole 121, 131 on a top thereof. In addition, the axial-hole 121 of the male connector 12 is of an elliptical shape.

Refer now to the assembly in accordance with the one shown in FIG. 1. Each one of the linkages 10 is attached to one another nearby with the male connector 12 and the female connector 13 thereof to form said transmission chain belt 100 by pivotally attaching the connecting shafts 20 into the axial-holes of male connectors 12 and the female connectors 13. As the sprocket 300 begins its operation and rotation, the tooth portions 310 of the sprocket 300 engage into the blind-perforations 14 of the linkages 10 one by one to drive the transmission belt 100 to rotate along a circulating path and to drive said transmission device 200.

In accordance with the above, the linkage 10 of the present invention provides the structure of a blind-perforation 14 for driving the tooth portions 310 of the sprocket 300; therefore, during its operation, the accidents and dangers of having parts and external matters falling in or having operator fingers being rolled in can be prevented.

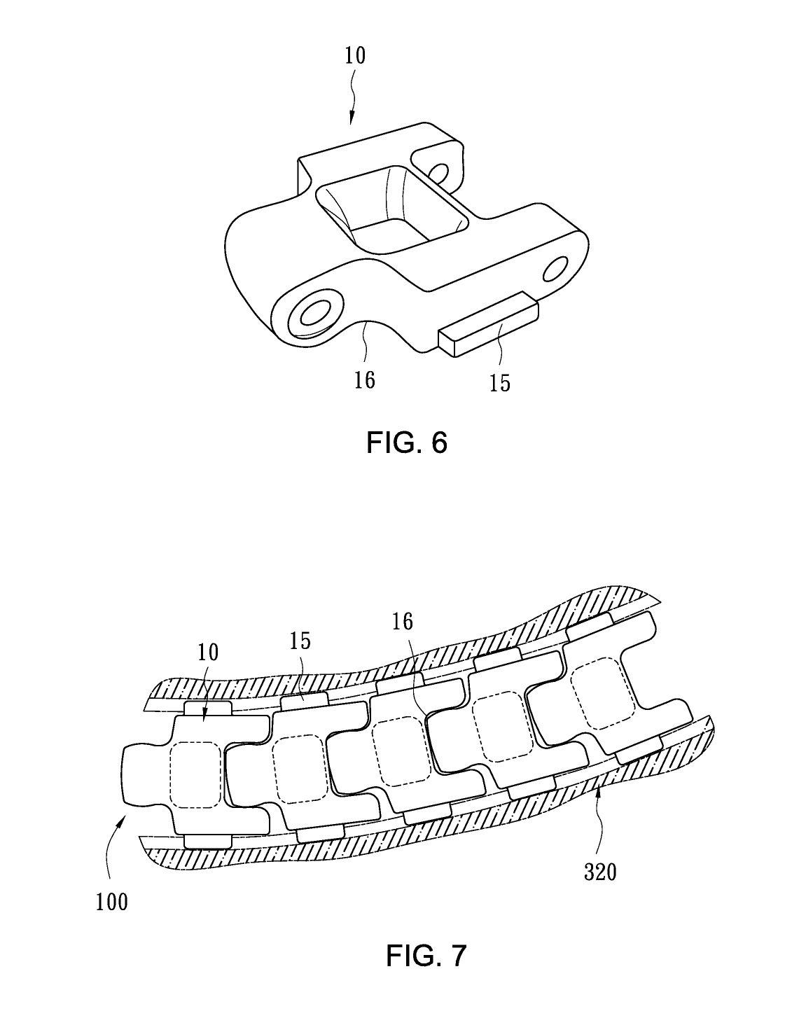

Furthermore, as shown in FIG. 6, the linkage 10 of the transmission chain belt 100 of the present invention further comprises two sliding blocks 15 provided on two sides of the linkage body 11 and two circular concave portions 16 provided between two sides of the male connector 12 and the linkage body 11. A shown in FIG. 7, the sliding blocks 15 are provided to allow the transmission chain belt 100 to move along a track 320 of a curve path, and the circular concave portions 16 are provided to allow the linkages 10 to be connected with each other during curves in order to ensure the operation of the transmission chain belt 100.

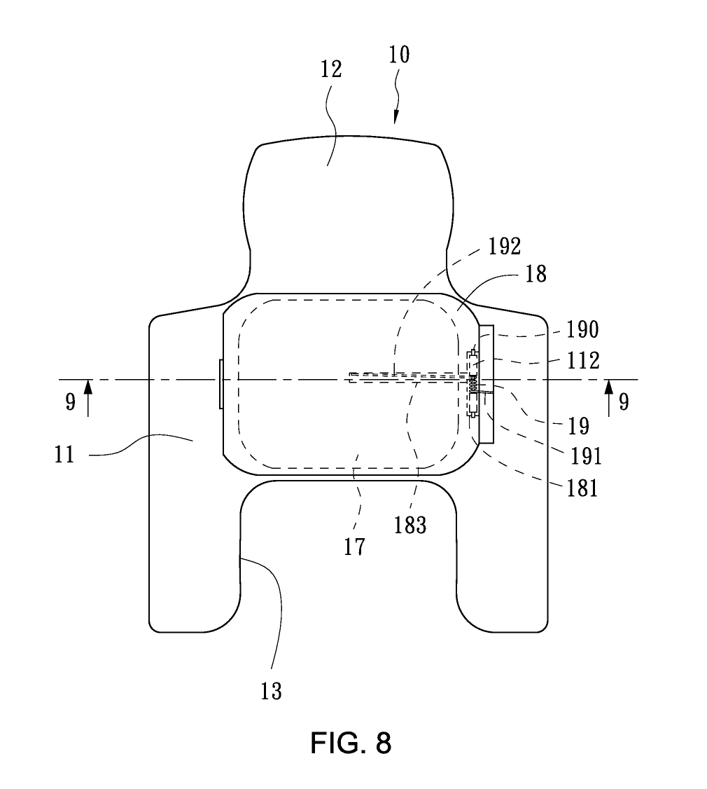

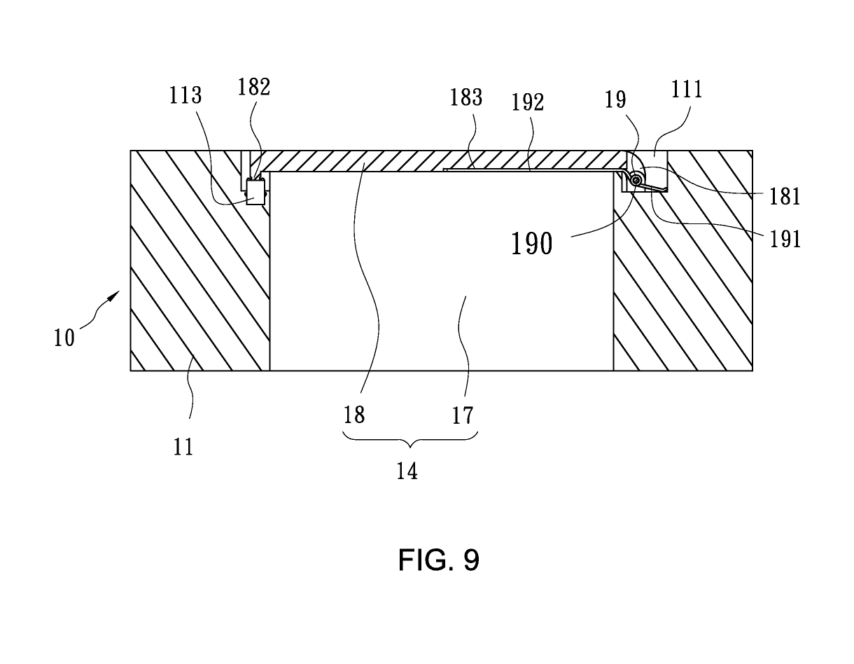

FIGS. 8 and 9 show a second embodiment of the modular transmission chain belt of the present invention. The operation of the second embodiment of the transmission chain belt is identical to the ones of the abovementioned first embodiment; therefore, details thereof is omitted.

The second embodiment is characterized in that: each one of the linkage 10 comprises a linkage body 11, a male connector 12 and a female connector 13 provided on two ends of the linkage body 11, a through-hole 17 penetrating top and bottom surfaces thereof and a lid 18 pivotally attached on top of the through-hole 17, a torsion spring 19, a slot 111 provided on top of the through-hole 17, a connecting block 112 provided on one side of the slot 111, a press-type lock 113 provided on another side of the slot 111.

Said lid 18 comprises a connecting portion 181 and a locking portion 182 on two sides thereof; and wherein said torsion spring 19 attached to an axial pin 190 is arranged on said connecting portion 181 of said lid 18 and said connecting block 112 of said linkage body 11. Said locking portion 182 of said lid 18 is provided for said press-type lock 113 of said linkage body 11 to be secured thereon. Said torsion spring 19 comprises a first end 191 and a second end 192; and wherein said first end 191 abuts said slot 111 and said second end 192 abuts a guiding slot 183 on an inner side of said lid 18.

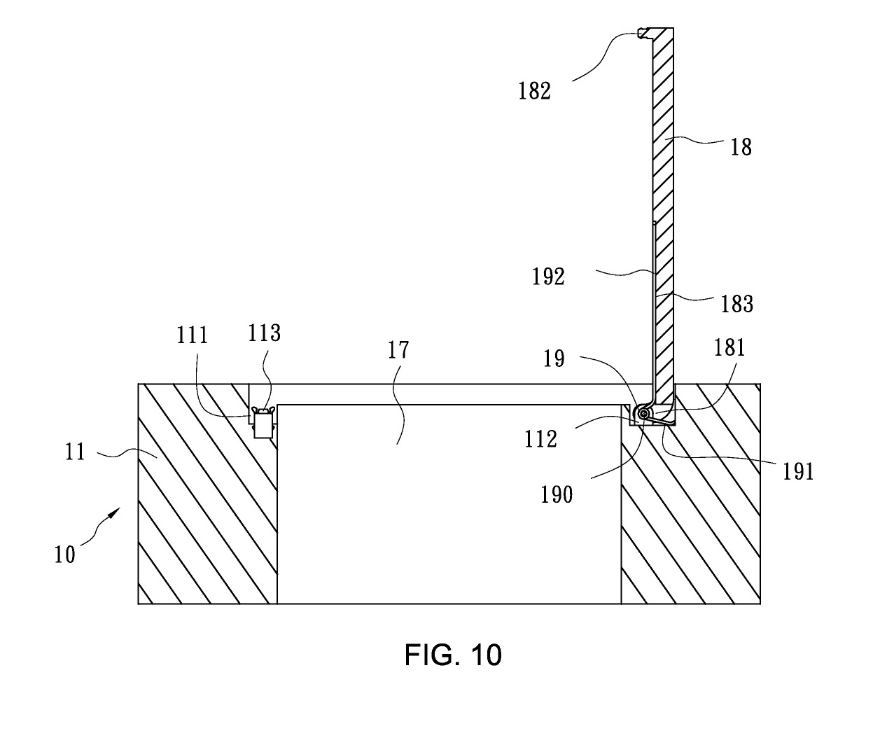

As shown in FIG. 9, a blind-perforation 14 is defined by said lid 18 and said through-hole 17 as said lid 18 is covered on top of said through-hole 17 such that the top surface of the linkage 10 is closed to prevent external matters from falling in. As shown in FIG. 10, in order to clean the through-hole 17 of the linkage 10, one can only press on the lid 18 such that the connecting block 182 disengages from the press-type lock 113 and the second end 192 of the lid 18 is then automatically lifted due to the spring force of the torsion spring 19, causing the lid 18 to be lifted away from the through-hole 17 and making the through-hole to be opened to allow cleaning of the through-hole 17.

Therefore, by utilizing a moveable lid 18 covering on top of the through-hole 17, not only the structure of a blind-perforation 14 can be constructed to prevent falling-in of external matters, cleaning operation of through-hole 17 can too be easily and conveniently achieved via the lifting and closing of the lid 18. In addition, as the lid 19 covers the through-hole 17, the accidents and dangers associated with the rolling in of operator fingers or garments can too be prevented.

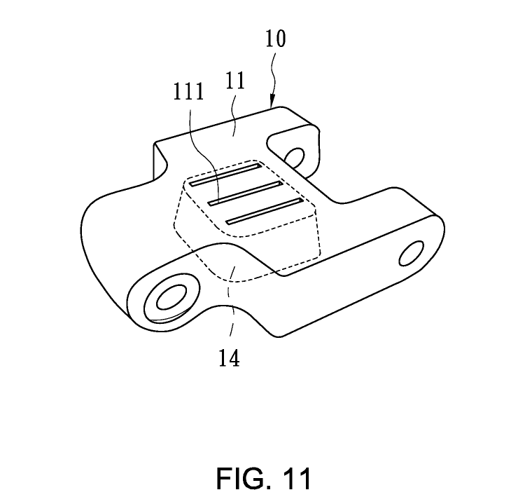

It should be pointed out that, referring to FIG. 11, the linkage body 11 of the linkage 10 is further provided with a plurality of fine grooves 111. The fine grooves 111 extend from a bottom portion of the blind-perforation 14 through the bottom surface of the linkage body 11 and serve to dissipate moisture from within the blind-perforation 14. Moreover, the fine grooves 111 are so thin that neither a foreign object nor a human finger can be inserted therein; thus, safety of use is ensured.

What is claimed is:

1. A modular transmission chain belt for driving a transmission device, said transmission chain belt being driven by a sprocket having a plurality of tooth portions provided for driving said transmission chain belt, comprising:
a plurality of linkages, comprising a linkage body, a male connector and a female connector provided on two ends of said linkage body, a blind-perforation provided on a bottom surface of said linkage body, each one of said linkages attached to one another nearby with said male connector and said female connector thereof to form said transmission chain belt, each one of said tooth portions engaged into said blind-perforation of said linkage one by one to drive said transmission belt to rotate along a circulating path; and
a plurality of connecting shafts, pivotally attached to said male connector and said female connector of said linkages.

2. The modular transmission chain belt as claimed in claim 1, wherein said blind-perforation of each one of said linkages comprises four perforation walls; and wherein two perforation walls corresponding to each other are of an arc shape.

3. The modular transmission chain belt as claimed in claim 1, wherein said each one of said linkages further comprises two sliding blocks arranged on two sides thereof.

4. The modular transmission chain belt as claimed in claim 1, further comprises a circular concave portion provided between two sides of said male connector of said plurality of linkages and said linkage body.

5. The modular transmission chain belt as claimed in claim 1, wherein said male connector and said female connector of each one of said linkages are of a reverse-U shape; and wherein each one of said male connectors and said female connectors further comprises an axial-hole on a top thereof.

6. The modular transmission chain belt as claimed in claim 5, wherein said axial hole of said male connector is of an elliptical shape.

7. The modular transmission chain belt as claimed in claim 1, wherein each said linkage has a plurality of fine grooves extending from a bottom portion of the blind-perforation of said linkage through the bottom surface of the linkage body of said linkage.

8. A modular transmission chain belt for driving a transmission device, said transmission chain belt being driven by a sprocket having a plurality of tooth portions provided for driving said transmission chain belt, comprising:
a plurality of linkage, comprising a linkage body, a male connector and a female connector provided on two ends of said linkage body, a through-hole penetrating top and bottom surfaces thereof and a lid pivotally attached on top of said through-hole such that a blind-perforation is defined by said lid and said through-hole as said lid is covered on top of said through-hole and such that said through-hole is opened as said lid is lifted away from said through-hole, provided on a bottom surface of said linkage body, each one of said linkages attached to one another nearby with said male connector and said female connector thereof to form said transmission chain belt, each one of said tooth portions engaged into said blind-perforation of said linkage one by one to drive said transmission belt to rotate along a circulating path; and
a plurality of connecting shaft, pivotally attached to said male connector and said female connector of said linkages.

9. The modular transmission chain belt as claimed in claim 8, wherein each one of said linkage further comprises a torsion spring, a slot provided on top of said through-hole, a connecting block provided on one side of said slot, a press-type lock provided on another side of said slot, said lid comprising a connecting portion and a locking portion on two sides thereof; and wherein said torsion spring attached to an axial pin is arranged on said connecting portion of said lid and said connecting block of said linkage body, said locking portion of said lid is provided for said press-type lock of said linkage body to be secured thereon, said torsion spring comprises a first end and a second end; and wherein said first end abuts said slot and said second end abuts an inner side of said lid.

10. The modular transmission chain belt as claimed in claim 8, wherein said through-hole of each one of said linkages comprises four perforation walls; and wherein two perforation walls corresponding to each other are of an arc shape.

11. The modular transmission chain belt as claimed in claim 8, wherein each one of said linkages further comprises two sliding blocks arranged on two sides thereof.

12. The modular transmission chain belt as claimed in claim 8, wherein said male connector and said female connector of each one of said linkages are of a reverse-U shape; and wherein each one of said male connectors and said female connectors further comprises an axial-hole on a top thereof.
